(19) United States
(12) Patent Application Publication
(10) Pub. No.: US 2023/0184316 A1
(43) Pub. Date: Jun. 15, 2023

(54) METHOD FOR PRESSING A GREEN COMPACT

(71) Applicant: Miba Sinter Austria GmbH, Laakirchen (AT)

(72) Inventors: David JOCHER, Ebensee (AT); Christian KRONBERGER, Vorchdorf (AT); Martin OHLER, Vorchdorf (AT); Horst ROESSLER, Krenglbach (AT)

(73) Assignee: Miba Sinter Austria GmbH, Laakirchen (AT)

(21) Appl. No.: 17/992,043

(22) Filed: Nov. 22, 2022

(30) Foreign Application Priority Data
Dec. 13, 2021 (AT) A50992/2021

(51) Int. Cl. F16H 55/17; B22F 3/03; B22F 5/08

(52) U.S. Cl. CPC F16H 55/17; B22F 3/03; B22F 5/085; B22F 1/10

(57) ABSTRACT

According to a method for pressing a green compact from a sintering powder for producing a gear having a first track and a second track, wherein a first helical toothing with a first helix angle and a first diameter is produced as the first track and a second helical toothing with a second helix angle and a second diameter is produced as the second track, the sintering powder is filled into a mold cavity of a die, and then the sintering powder is pressed to form the green compact with an upper stamp and a lower stamp, and wherein the first and the second helical toothings are produced having the same pitch height.

### CROSS REFERENCE TO RELATED APPLICATIONS

Applicant claims priority under 35 U.S.C. §119 of Austrian Application No. A50992/2021 filed Dec. 13, 2021, the disclosure of which is incorporated by reference.

### BACKGROUND OF THE INVENTION

### 1. Field of the Invention

The invention relates to a method for pressing a green compact from a sintering powder for producing a gear having a first track and a second track, wherein a first helical toothing with a first helix angle and a first diameter is produced as the first track and a second helical toothing with a second helix angle and a second diameter is produced as the second track, according to which method the sintering powder is filled into a mold cavity of a die, and then the sintering powder is pressed to form the green compact with an upper stamp and a lower stamp.

The invention further relates to a method for powder-metallurgically producing a gear having a first track and a second track from a sintering powder, wherein a first helical toothing with a first helix angle and a first diameter is produced as the first track and a second helical toothing with a second helix angle and a second diameter is produced as the second track, comprising the steps: pressing the sintering powder to a green compact and sintering the green compact to a sintered gear.

The invention further relates to a gear having a first track and a second track from a sintering powder, wherein the first track is a first helical toothing with a first helix angle and a first diameter and the second track is a second helical toothing with a second helix angle and a second diameter.

The invention also relates to an E-axle of an electric vehicle comprising a planetary gearbox with a planetary gear.

### 2. Description of the Related Art

In the prior art, the term “E-axle” refers to solutions for the electric drive of battery-powered electric vehicles and hybrid applications. The used electric motor, which converts electrical energy into mechanical energy, transfers the torque onto a gearbox. The gearbox translates the rotational speed of the electric motor to the level required at the drive shaft and simultaneously amplifies the motor torque. E-axles are often combined with single-stage or two-stage helical gear units or planetary gearboxes. Hence, axially parallel or coaxial architectures can be implemented.

In planetary gearboxes, stepped planetary gears (double planetary gears) having different gear diameters are used to realize the translation. The toothings of the double planetary gears mesh on the one hand with the sun gear and on the other hand with the internal gear. The angular position of the toothings must be manufactured very precisely, otherwise it is difficult or impossible to assemble the planetary gearbox.

Such a double planetary gear, a method and a tool for its production are known, for example, from AT 521 836 A2. According to this publication, a green compact is produced from a sintering powder with a first track and a second track, wherein the first track has a first helical toothing and the second track has a second helical toothing. The sintering powder is filled into a mold cavity of a die and is subsequently pressed to a green compact with an upper stamp and a lower stamp. The sintering powder, after having been filled into the die, is partially moved into the upper stamp and the upper stamp is used as a further die for the formation of the first track. A web is formed between the two tracks using the upper stamp and the lower stamp. The gear produced from this green compact is embodied in one piece and an annular groove is formed between the two tracks after removal of the web.

### SUMMARY OF THE INVENTION

The present invention is based on the object of improving the production of an E-axle and/or a single-piece double gear with helical toothings.

The object of the invention is achieved by the initially mentioned method according to which it is provided that the first and the second helical toothings are produced having the same pitch height.

Furthermore, the object of the invention is achieved by the method for powder-metallurgical production of a gear, in which pressing the sintering powder is performed according to the invention and the region of the first track directly adjoining the second track is removed prior to sintering the green compact or after sintering the green compact to the sintered gear.

The object of the invention is, moreover, achieved in the initially mentioned gear in that the first and the second helical toothing have the same pitch height.

The object of the invention is also achieved by the initially mentioned E-axle in which the gear is formed according to the invention.

The advantage of this is that by the formation of the two tracks with the same pitch height, it is possible to simplify the tool structure by the demolding of the gear being simplified. As a side effect, hence, it is also possible, for example, to press the green compact for the gear with an undivided upper stamp. By the simplification of the tool and/or the reduction of the stamp divisions, the tolerance field in positioning the tool parts with respect to one another can be reduced, whereby the accuracy of the double gear can be increased, in particular by increasing the accuracy of the angular positions of the toothings to one another. This, in turn, improves the timing in the E-axle and/or other applications in which the (temporal) coordination of the engagement of the two tracks in further gears is relevant.

According to an embodiment variant of the invention, it can be provided that the second track is produced having a second diameter which is by between 10% and 250% larger than the first diameter of the first track. The advantage of the equal pitch height of the toothings takes effect in particular in the production of double gears with such diameter differences of the tracks, since hence the aforementioned effects can be further improved.

Furthermore, it is advantageous for the production of the green compact if, according to another embodiment variant of the invention, the first track and/or the second track are produced with a helix angle remaining equal over the entire tooth height, since hence the demolding of the green compact from the pressing tool can be simplified.

According to another embodiment variant of the invention, it can be provided that the first track is produced with a smaller diameter than the second track, wherein the first track is produced with a tooth length which is by at least 50% larger than the tooth length of the second track, since hence the demolding capability of the green compact can also be improved.

For the same reason, according to a further embodiment variant of the invention, it can also be provided that the first track is produced with a helix angle of between 5° and 40°.

The demolding capability of the green compact can also be improved by an embodiment variant of the invention in which the green compact is produced having a two-part lower stamp, which comprises a radially outer lower stamp part and a radially inner lower stamp part, wherein the radially outer lower stamp part is inserted in a fixed manner and the green compact is ejected with the radially inner lower stamp part.

The aforementioned effects can be improved if, according to an embodiment variant, the green compact is produced with an undivided upper stamp.

For the purpose of better understanding of the invention, it will be elucidated in more detail by means of the figures below.

### BRIEF DESCRIPTION OF THE DRAWINGS

Other objects and features of the invention will become apparent from the following detailed description considered in connection with the accompanying drawings. It is to be understood, however, that the drawings are designed as an illustration only and not as a definition of the limits of the invention.

In the drawings,

FIG. 1 shows a multi-track gear in an oblique view in a very simplified schematic representation;

FIG. 2 shows an E-axle in a very simplified schematic representation;

FIG. 3 shows the correlation between helix angle and pitch height of a helical toothing in a very simplified schematic representation; and

FIG. 4 shows a cutout from a device for producing a green compact for the production of a multi-track gear in a very simplified schematic representation.

### DETAILED DESCRIPTION OF PREFERRED EMBODIMENTS

First of all, it is to be noted that in the different embodiments described, equal parts are provided with equal reference numbers and/or equal component designations, where the disclosures contained in the entire description may be analogously transferred to equal parts with equal reference numbers and/or equal component designations. Moreover, the specifications of location, such as at the top, at the bottom, at the side, chosen in the description refer to the directly described and depicted figure and in case of a change of position, these specifications of location are to be analogously transferred to the new position.

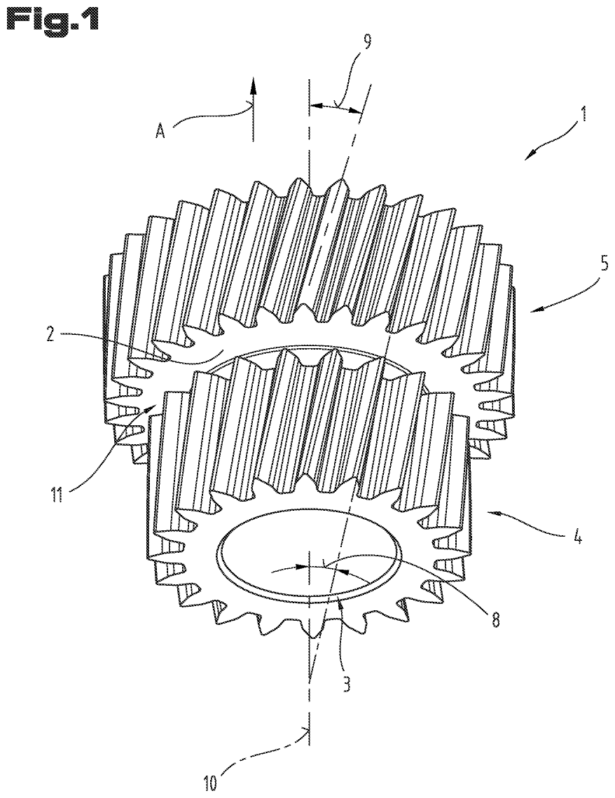

FIG. 1 shows a gear 1. The gear 1 comprises a gear body 2. In the gear body 2, a recess 3, which extends in the axial direction, in particular through the gear 1, is formed to accommodate a shaft or axle that is not shown. Furthermore, the gear body 2 on its radially outer surface has a first track with a first end toothing in the form of a first helical toothing 4 and a second track with a second end toothing in the form of a second helical toothing 5.

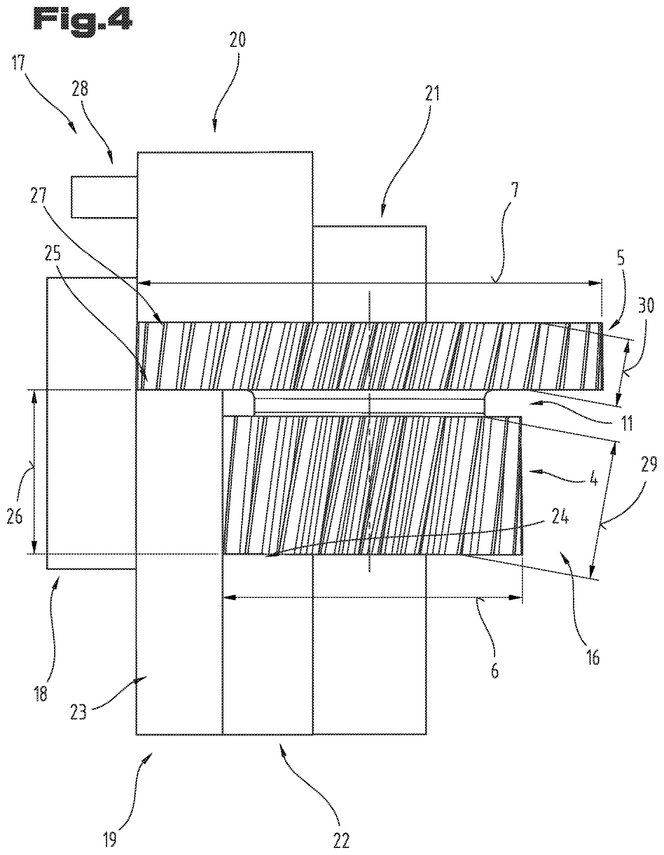

As can be better seen from FIG. 4, the first track has a first diameter 6 and the second track has a second diameter 7. The first helical toothing 4 has a first helix angle 8 and the second helical toothing has a second helix angle 9.

The helix angle β determines the direction of the teeth of the helical toothings 8, 9 and is measured between the longitudinal central axis 10 in the axial direction A and the tooth of the respective helical toothing 4, 5 at the pitch circle diameter.

The pitch circle diameter is that diameter of a gear at which the tooth pitch p occurs exactly z times, wherein z is the number of teeth. The tooth pitch p is the length of a pitch circle arch between two consecutive flanks of the same name (right-hand or left-hand flanks).

The diameters 6, 7 of the two tracks are determined at the radially outermost points of the tooth heads of the teeth of the respective helical toothing 4, 5.

The two helical toothings 4, 5 have teeth which are inclined in the same direction, as can be seen from FIG. 1. Thus, both helical toothings 4, 5 either have left-rising or right-rising teeth. The size (the value) of the first helix angle 8, however, is different from, in particular smaller than, the size (the value) of the second helix angle 9. Furthermore, the diameter of the first helical toothing 4 is different from, in particular smaller than the diameter of the second helical toothing 5.

A groove, in particular an annular groove 12, which separates the two end toothings 4, 5 from one another, is formed in the axial direction 11 between the tracks and/or the two end toothings 4, 5.

The gear 1 is preferably intended for a multi-stage, for example two-stage, planetary gear with double-row planets. However, the gear 1 can also be used in other applications.

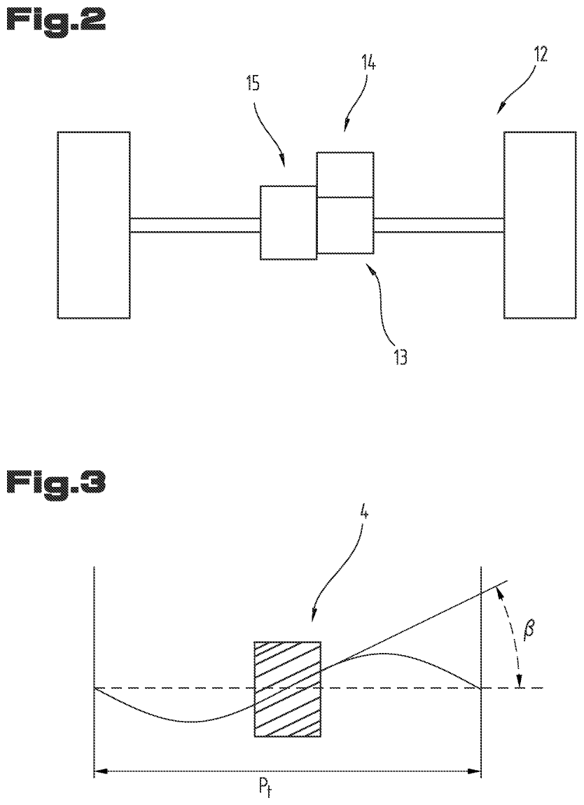

In particular, the gear 1 is intended for an E-axle 12 of an electric vehicle, which is shown in a simplified manner and by way of example in FIG. 2. Besides an electric motor 13 and the power electronics 14, the E-axle 12 also comprises a planetary gearbox 15 with the gear 1 as the planetary gear. As is per se known, a planetary gearbox 15, besides the at least one planetary gear, also comprises a central sun gear and an internal gear surrounding all gears, wherein the internal gear is in operative connection with the sun gear via the at least one planetary gear.

In the gear 1, it is provided that the first and the second helical toothings 4, 5 have the same pitch height p_{z}. As is known, the pitch height indicates the height of an imaginary cylinder, in which the gear performs a guided rotation by 360° along its toothing. In this respect, FIG. 3 shows the correlation between the pitch height p_{z} and the helix angle β.

Preferably, the first and the second helical toothing 4, 5 have the same pitch height p_{z}, which is selected from a range of 180 mm to 960 mm.

The gear 1 is produced powder-metallurgically from an, in particular metal, sintering powder. The sintering powder can, for example, be a steel powder, wherein other (pre-alloyed) powders can be used as well. Furthermore, the powder can comprise the usual additives, such as lubricant, etc. This (optionally premixed) sintering powder is pressed to a so-called green compact 16 in a first step.

A preferred embodiment variant of a device 17 for producing the green compact 16 for the gear 1 is shown in extracts in FIG. 4. As powder presses are per se known in sintering technology, the representation of other details of the powder press, such as drives, etc., was dispensed with, since these details are anyway known to the person skilled in the art, for example from EP 1 952 975 A1.

The device 17 comprises a die 18, a lower stamp 19 and an upper stamp 20. A core rod 21 can be arranged to form the recess 3 in the gear 1 (see FIG. 1).

FIG. 4 shows the die 18, the lower stamp 19 and the upper stamp 20, in each case only half. Furthermore, this depiction shows the position after pressing when the green compact 16 has been pressed, however, has not yet been ejected.

The die 17 comprises a mold cavity. The mold cavity is measured such in terms of its size that the lower stamp 19 and the upper stamp 20 can partially immerse into it, as can be seen from FIG. 4.

The upper stamp 20 can have a first upper stamp part and a second upper stamp part, wherein the first upper stamp part is arranged within the second upper stamp part as seen in the radial direction and/or is embodied in multiple parts in general. According to an embodiment variant of the device 17, the upper stamp 20 can, however, also be formed in one piece without a division into a first and a second upper stamp part, as is shown in FIG. 4. The green compact 16 can also be produced with an undivided upper stamp 20.

The lower stamp 19 has a first lower stamp part 22 and a second lower stamp part 23 and/or consists of these two lower stamp parts 22, 23. The first lower stamp part 22 is arranged within the second lower stamp part 23 as seen in the radial direction, as can also be seen from FIG. 4. The first lower stamp part 22 can thus also be referred to as radially inner lower stamp part 22 and the second lower stamp part 23 can also be referred to as radially outer lower stamp part 23.

Furthermore, in the preferred embodiment variant of the device 17, the radially outer lower stamp part 22 is rotationally fixed (fixedly clamped) and the radially inner lower stamp part 23 is inserted being mounted in a bearing, such that the radially inner lower stamp part 23 is adjustable in axial direction and rotationally. Thus, the green compact 16 can be ejected upwardly (referring to FIG. 4) from the mold cavity of the die 18 after pressing with the radially inner lower stamp part 23.

In the course of the production of the green compact 16, the device 17 goes through different positions, namely a filling position, a compression position and an ejection position.

In the filling position, the, in particular metal, sintering powder for producing the green compact 16 for the gear 1 (see FIG. 1) is filled into the mold cavity of the die 18. In this regard, a pressing surface 24 of the first lower stamp part 22 is arranged at a distance 26 below a pressing surface 25 of the second lower stamp part 23. However, the distance 26 can also be larger to hence have a larger compression path for the sintering powder with the first lower stamp part 22 if the first lower stamp part 22 also performs a compression stroke.

For the sake of completeness, it should be noted that the sintering powder is pressed to the green compact 16 between the pressing surfaces 24, 25 and a pressing surface 27 of the upper stamp 20 and these accordingly face the mold cavity of the die 18.

To compress and/or press the sintering powder, the upper stamp 20 is lowered after the mold cavity has been filled, such that the upper stamp 20 with its pressing surface 27 presses the sintering powder downwards against the lower stamp 19. Optionally the first lower stamp part 22 can perform a lifting movement during pressing.

As can be seen from FIG. 4, the first track with the first end toothing 4 is formed between the upper stamp 20 and the first lower stamp part 22 and the second track with the second end toothing 5 is formed between the upper stamp 20 and the second lower stamp part 23. Accordingly, the wall, which surrounds the mold cavity of the die 8, for the formation of the second helical toothing 5 comprises a corresponding (complementary) internal toothing and the radially inner surface of the second lower stamp part 23, which co-defines the mold cavity of the first track, for the formation of the first helical toothing 4 comprises a corresponding (complementary) internal toothing. For the sake of better overview, these two end toothings are not further emphasized in FIG. 4.

Since an internal toothing is formed on the inner surface of the die 18, as has been stated above, the upper stamp 20 comprises an external toothing which engages in the internal toothing of the die 18, to thus allow for height adjustment of the first upper stamp 20 after immersion in the die 18. Likewise, the first lower stamp part 22 comprises an external toothing on its lateral surface in order to be able to mesh with the internal toothing of the second lower stamp part 23. The outer lateral surface of the second lower stamp part 23 comprises an external toothing which engages in said internal toothing of the die 18.

After completion of the compression, the green compact 16 is ejected from the device 17. For this purpose, the upper stamp 20 is moved upwards. The green compact 16 can be ejected by an upward movement of the first lower stamp part 22. Alternatively or additionally to this, optionally with the first lower stamp part 22 stationary, the die 18 can perform a downward movement after the upper stamp 20 has been raised. Combined movements are possible, such that, for example, the first upper stamp 20 is moved upwards and the die 18 is moved downwards (simultaneously). For the movement of the die 18, it accordingly can be arranged with a bearing mounted so as to be rotatable.

Further, for the movement of the upper stamp 20, a control plate 28 can be provided in the device 17, via which the upper stamp 20 can be driven.

On the finished green compact 16, the two helical toothings 4, 5 are formed with the same pitch height. The internal toothing of the die and of the second lower stamp part 23 are formed accordingly.

According to an embodiment variant, the green compact 18 can also be manufactured with regions of different density. For example, the first track may have a density different from the second track.

Sintering the green compact 18 can be performed in one step or in multiple steps according to the prior art. In this respect, reference is made to the relevant prior art. The temperatures during sintering can, for example, amount to between 750° C. and 1350° C. The green compact 16 can be kept at this temperature for between 10 minutes and 65 minutes.

FIG. 4 shows the green compact 16 already with the annular groove 11. Although it is possible to form the annular groove 11 in the device 17 with a corresponding tool architecture, said annular groove 11 is preferably removed before sintering the green compact 16 or after sintering the green compact 16 to the sintered gear 1 by removing material from the area of the first track immediately adjacent to the second track. The green compact 16 is thus produced in particular with the first track directly adjoining the second track, so that the first helical toothing 4 is thus formed directly on the axial end face of the second track.

The removal of the material is carried out in particular by machining. The annular groove 11 is preferably not further surface processed after this material machining. As a result of this formation of the annular groove 11, the two tracks are present in the finished gear 1 without a radial overlapping region and behind one another and separated from one another in the axial direction A.

Preferably, the first track is produced with a smaller diameter 6 than the second track. According to an embodiment variant, it can be provided that the second track is produced with a second diameter 7 that is larger than the first diameter 6 of the first track by between 10% and 250%, in particular between 15% and 240%.

Furthermore, it can be provided that the first track and/or the second track are produced with a helix angle 8, 9 remaining equal over the entire tooth height, i.e. for example the first and/or second helical toothing 4, 5 can have flat tooth flanks. However, the tooth flanks of the first and/or second helical toothing 4, 5 can have a deviating shape, for example be cambered and/or evolvent-shaped.

According to a further embodiment variant, it can be provided that the diameter 6 of the first track is produced to be smaller than the diameter 7 of the second track, wherein the first track is provided with a tooth length 29 which is by at least 50% larger than the tooth length 30 of the second track. In other words, the first track is wider than the second track in the axial direction A.

Furthermore, it can be provided that the second track is produced with a helix angle 8 of between 5° and 40°.

According to another embodiment variant, it can be provided that a ratio between the second helix angle 9 of the second track with the larger diameter and the first helix angle 8 of the first track with the smaller diameter is selected from a range of 1.1:1 to 3.5:1.

The exemplary embodiments show possible embodiment variants, while it should be noted at this point that combinations of the individual embodiment variants are also possible.

Finally, as a matter of form, it should be noted that for ease of understanding of the structure of the gear 1 and/or the device 17, these are not obligatorily depicted to scale.

Although only a few embodiments of the present invention have been shown and described, it is to be understood that many changes and modifications may be made thereunto without departing from the spirit and scope of the invention.

### LIST OF REFERENCE NUMBERS

1 Gear A axial direction
2 Gear body
3 Recess
4 Helical toothing
5 Helical toothing
6 Diameter
7 Diameter
8 Helix angle
9 Helix angle
10 Longitudinal central axis
11 Annular groove
12 E-axle
13 Electric motor
14 Power electronics
15 Planetary gearbox
16 Green compact
17 Device
18 Die
19 Lower stamp
20 Upper stamp
21 Core rod
22 Lower stamp part
23 Lower stamp part
24 Pressing surface
25 Pressing surface
26 Distance
27 Pressing surface
28 Control plate
29 Tooth length
30 Tooth length

1. A method for pressing a green compact (16) from a sintering powder for producing a gear (1) having a first track and a second track, wherein a first helical toothing (4) with a first helix angle (8) and a first diameter (6) is produced as the first track and a second helical toothing (5) with a second helix angle (9) and a second diameter (7) is produced as the second track, according to which method the sintering powder is filled into a mold cavity of a die (18), and then the sintering powder is pressed to form the green compact (16) with an upper stamp (20) and a lower stamp (19), wherein the first and the second helical toothings (4, 5) are produced having the same pitch height.

2. The method according to claim 1, wherein the second track is produced having a second diameter (7) which is between 10% and 250% larger than the first diameter (6) of the first track.

3. The method according to claim 1, wherein the first track and/or the second track are produced with a helix angle (8, 9) remaining equal over the entire tooth height.

4. The method according to claim 1, wherein the first track is produced with a smaller diameter (6) than the second track, wherein the first track is produced with a tooth length (29) which is at least 50% larger than a tooth length (30) of the second track.

5. The method according to claim 1, wherein the first track is produced with a helix angle (8) of between 5° and 40°.

6. The method according to claim 1, wherein the green compact (16) is produced with an at least two-part lower stamp (19), which comprises a radially outer lower stamp part (23) and a radially inner lower stamp part (22), wherein the radially outer lower stamp part (23) is inserted in a rotationally fixed manner and the green compact (16) is ejected with the radially inner lower stamp part (22).

7. The method according to claim 1, wherein the green compact (16) is produced with an undivided upper stamp (20).

8. A method for powder-metallurgically producing a gear (1) having a first track and a second track from a sintering powder, wherein a first helical toothing (4) with a first helix angle (8) and a first diameter (6) is produced as the first track and a second helical toothing (5) with a second helix angle (9) and a second diameter (7) is produced as the second track, comprising the steps: pressing the sintering powder to a green compact (16) according to the method of claim 1; sintering the green compact (16) to the sintered gear (1), wherein prior to sintering the green compact (16) or after sintering the green compact (16) to the sintered gear (1), the region of the first track directly adjoining the second track is removed.

9. A gear (1) made of a sintering powder having a first track and a second track, wherein the first track is a first helical toothing (4) with a first helix angle (8) and a first diameter (6) and the second track is a second helical toothing (5) with a second helix angle (9) and a second diameter (7), wherein the first and the second helical toothings (4, 5) have the same pitch height.

10. An E-axle (12) of an electric vehicle comprising a planetary gearbox (15) with a planetary gear, wherein the planetary gear is embodied as the gear (1) according to claim 9.
